(19) United States
(12) Patent Application Publication
(10) Pub. No.: US 2004/0031475 A1
(43) Pub. Date: Feb. 19, 2004

(54) Saw blade mounting arrangement

(76) Inventor: Charles E. Markley, Anaheim Hills, CA (US)

Correspondence Address: STETINA BRUNDA GARRED & BRUCKER, 75 ENTERPRISE, SUITE 250, ALISO VIEJO, CA, 92656, US

(21) Appl. No.: 10/222,453

(22) Filed: Aug. 16, 2002

(51) Int. Cl. B28D 1/04

(52) U.S. Cl. 125/13.01

(57) ABSTRACT

A portable concrete saw has a rotating concrete cutting blade that is rotated about a rotational axis by rotating drive shaft mounted to the saw and driven by a motor on the saw. A threaded recess in a distal end of the drive shaft is aligned parallel to the rotational axis but offset from that axis. An arbor sleeve is mounted to rotates with the distal end of the drive shaft. The sleeve has a non-symmetric blade mounting portion thereon to orientate the cutting blade in only one orientation. The sleeve has a hole therethrough parallel to the rotational axis through which the distal end of the shaft extends. A clamping plate has a recess aligned with and configured to receive at least one portion of the blade mounting portion in order to align the plate to rotate about the rotational axis. The plate has a geometric center with a hole through the plate parallel to the rotational axis but offset from the geometric center. A bolt extends through the hole in the plate and threadingly engages the recess in the distal end of the drive shaft to clamp the blade between the arbor sleeve and the clamping plate.

### BACKGROUND OF THE INVENTION

Concrete cutting blades are formed by embedding diamond, carbide or other abrasive particles in a matrix that forms the cutting segments disposed around the periphery of a cutting blade. The blade has a central hole which is used to mount the blade on a drive shaft or arbor rotated by a motor. When these abrasive blades are used to cut concrete the direction of rotation of the cutting blade is important. If the blade is put on the arbor so that the blade rotates in the wrong direction, then the abrasive particles embedded in the cutting segments will be removed too fast, the cutting segments blade will wear out prematurely, and the blade may even overheat which causes further premature deterioration of the cutting blade.

To address this blade orientation problem, a non-symmetric arbor having three sides is described in U.S. Pat. No. 5,373,834 to Chiuminatta et al. While that arbor addresses the blade orientation problem, improvements could be made.

The current drive shafts have threaded male ends which use a mating nut to clamp the blade between a shoulder on the drive shaft and the nut that is placed on the threaded end of the shaft. The threaded end of the shaft can become damaged requiring replacement of the entire drive shaft with resulting increased cost and inability to use the saw during the replacement of the damaged drive shaft. Further, the nut can be over tightened, resulting in further damage to the threads or even twisting the shaft off, thus requiring replacement of the drive shaft. Moreover, the blade can become hot, causing thermal expansion of mating parts and inhibiting removal of the cutting blade until the blade and the blade mounting assembly has cooled. But it costs money to have workers wait for the blade and mounting parts to cool, and the saw cannot be used during that time. There is thus a need for an improved mounting for concrete cutting blades that avoids one or more of these deficiencies.

Moreover, because the blade rotates vibration will result if the blade and mounting components are not adequately balanced. Prior concrete saws sometimes used a flat on the drive shaft to locate and orientate the saw blade and parts to clamp the blade and frictionally drive the rotating blade. But the flat itself could provide an unbalance causing vibration. Further, the alignment was not always accurate or repeatable so that vibration occurred, especially after repeated use that resulted in wearing the surface being used for alignment. There is thus a need for an improved mounting arrangement that allows fast, repeatable and easy alignment of the parts to mount the rotating blade on these saws.

### BRIEF SUMMARY OF THE INVENTION

The above and other objectives are achieved by a portable concrete saw that has a rotating concrete cutting blade rotating about a rotational axis on a drive shaft mounted to the saw and driven by a motor on the saw. A threaded recess is provided in a distal end of the drive shaft. The recess is aligned parallel to the rotational axis but offset from that axis. An arbor sleeve is mounted to and rotates with the distal end of the drive shaft. The sleeve has a non-symmetric blade mounting portion thereon. The sleeve also advantageously has a hole therethrough parallel to the rotational axis, although the sleeve could be molded integrally with the drive shaft. The blade mounts on the mounting surface.

A clamping plate is provided with at least one part thereon that is aligned with and configured to abut or overlap at least one portion of the blade mounting portion in order to align the plate to rotate about the rotational axis. The abutting or overlapping part advantageously comprises a recess to engagingly receive the blade mounting portion. The clamping plate has a geometric center with a hole through the plate parallel to the rotational axis but offset from the geometric center. Alternatively, the clamping plate has a threaded fastener at the location of the hole with the fastener mounted to rotate independently of the clamping plate yet be restrained from being axially withdrawn from the plate. Preferably, a threaded fastener removably extends through the hole in the plate and threadingly engages the recess in the distal end of the drive shaft to grip the blade between the clamping plate and the arbor sleeve.

Advantageously the mounting portion has two straight sides and one curved side forming a generally triangular shape. Further, the mounting portion preferably but optionally includes a first structure extending orthogonal to the rotational axis with a first annular flange extending from the first structure generally parallel to and encircling the rotational axis and extending toward the clamping plate. The clamping plate also preferably includes a second structure extending orthogonal to the rotational axis with a second annular flange extending from the second structure generally parallel to and encircling the rotational axis and extending toward the first flange. The first and second structures preferably comprise radially extending portions of a disc forming a portion of the respective arbor sleeve and clamping plate. Both the arbor sleeve and clamping plate advantageously take the form of discs with circular peripheries. Advantageously, the first and second flanges frictionally engage opposing sides of the blade at the same distance from the rotational axis. Moreover, the mounting sleeve is advantageously fastened to the drive shaft by a shear pin.

In a further embodiment, the concrete saw has a drive shaft with an arbor sleeve connected to and rotating with the drive shaft. The sleeve having a non-symmetric blade mounting portion thereon, and a hole therethrough parallel to the rotational axis for mounting the sleeve on the drive shaft. A clamping plate is provide having at least one part thereon that is aligned with and configured to abut and/or overlap at least one portion of the blade mounting portion in order to align the plate to rotate about the rotational axis. The aligned part or parts advantageously comprise a recess configured to engage the periphery of the mounting arbor. The plate preferably has a geometric center with a hole through the plate parallel to the rotational axis but offset from the geometric center.

The further embodiment advantageously includes a threaded recess in a distal end of the drive shaft is aligned generally parallel to the rotational axis but offset from that axis. A threaded fastener extends through the hole in the plate and threadingly engaging the recess in the distal end of the drive shaft. The mounting portion advantageously, but optionally includes a first annular flange extending generally parallel to and encircling the rotational axis and extending toward the clamping plate, and the clamping plate also advantageously but optionally includes a second annular flange extending from the second structure generally parallel to and encircling the rotational axis and extending toward the first flange. The first and second flanges frictionally engage opposing sides of a concrete saw blade at the same distance from the rotational axis.

In a further variation, The clamping plate has a geometric center with a threaded fastener connected to the plate and extending parallel to the rotational axis and toward the arbor sleeve and offset from the geometric center. The threaded recess in the drive shaft engages the threaded fastener to clamp the blade between the clamping plate and the arbor sleeve as the plate is rotated to tighten the engaged threads.

There is also advantageously provided a method for mounting a rotating cutting blade on a portable concrete saw that rotates the blade about a rotational axis by a rotating drive shaft mounted to the saw and driven by a motor on the saw. The method includes placing a threaded recess in a distal end of the drive shaft and aligning the recess parallel to the rotational axis but offset from that axis. An arbor is to and rotates with the distal end of the drive shaft. The sleeve has a non-symmetric blade mounting portion thereon on which to mount the blade in only one orientation. The method further includes aligning a clamping plate having at least one projection thereon so the projection is aligned with and configured to overlap at least one portion of the blade mounting portion and align the plate to rotate about the rotational axis. The plate has a geometric center with a hole through the plate parallel to the rotational axis but offset from the geometric center.

Further advantages can be achieved in the above method by extending a threaded fastener through the hole in the plate and threadingly engaging the recess in the distal end of the drive shaft to clamp the blade between the arbor sleeve and the clamping plate. The method preferably forms the mounting portion to have two straight sides and one curved side to form a generally triangular shape, with the blade having a matching hole therein to engage the mounting portion.

The method further advantageously, but optionally, includes, providing a first annular flange extending from the arbor sleeve generally parallel to and encircling the rotational axis and extending toward the clamping plate, and providing the clamping plate with a second annular flange generally parallel to and encircling the rotational axis and extending toward the first flange, so the first and second flanges frictionally engage opposing sides of the cutting blade at a common radial distance from the rotational axis. Moreover, the mounting sleeve can be fastened to the drive shaft by a shear pin.

### BRIEF DESCRIPTION OF THE DRAWINGS

These as well as other features of the present invention will become more apparent upon reference to the drawings in which like numbers refer to like parts throughout, and wherein:

FIG. 1 is a perspective view showing a mounting arrangement for a saw blade looking along the drive shaft;

FIG. 2 is a perspective view showing a mounting arrangement for a saw blade looking toward the drive shaft;

FIG. 3 is a plan view of a clamping disc shown in FIG. 1;

FIG. 4 is a sectional view taken along line 4-4 of FIG. 3;

FIG. 5 is a plan view of an arbor sleeve shown in FIG. 1;

FIG. 6 is a sectional view taken along line 5-5 of FIG. 5;

FIG. 7 is an end view showing the arbor sleeve of FIG. 5 mounted on an arbor;

FIG. 8 shows the arbor clamp and arbor sleeve mounted on a concrete saw; and

FIG. 9 shows a partial cross-sectional view of the blade mounting assembly of FIG. 1.

### DETAILED DESCRIPTION

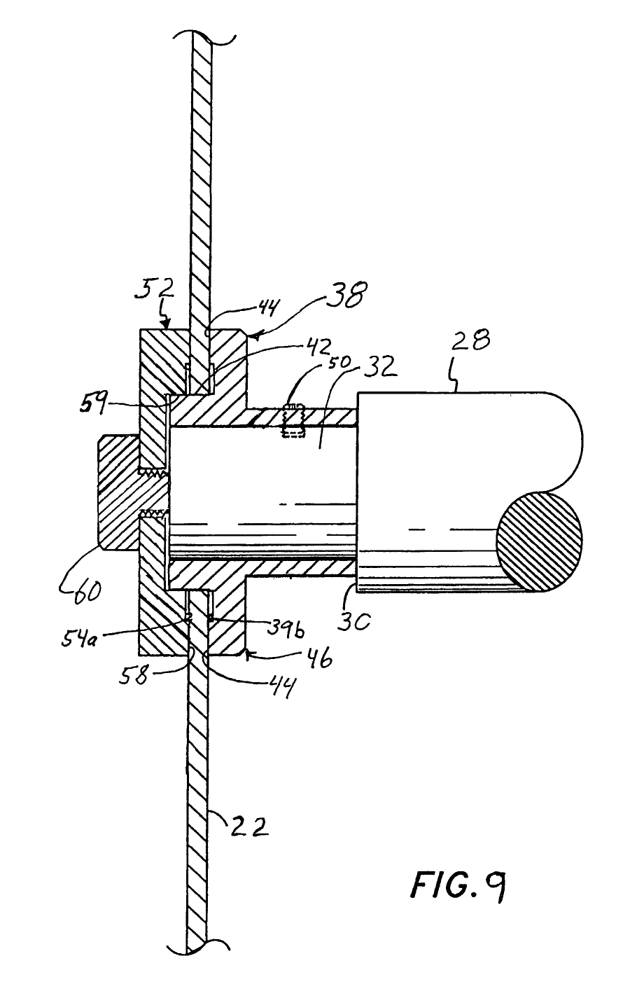

FIG. 8 shows a concrete saw 20 that moves on a surface being cut by a rotating, circular cutting blade 22. The saw 20 is supported on the concrete surface by wheels and a skid plate 24 that has a slot through which the cutting blade 22 extends during the cutting of the concrete. The cutting blade 22 is rotated by a motor 26 mounted on the saw 20. Such a saw is described in U.S. Pat. No. 4,769,201 to Chiuminatta, et. al. titled Method of Cutting Grooves in Concrete With A Soft Concrete Saw, and U.S. Pat. No. 5,429,109 to Chiuminatta, et. al. Titled Method and Apparatus for Cutting Wet Concrete. The entire contents of both patents are incorporated herein by reference.

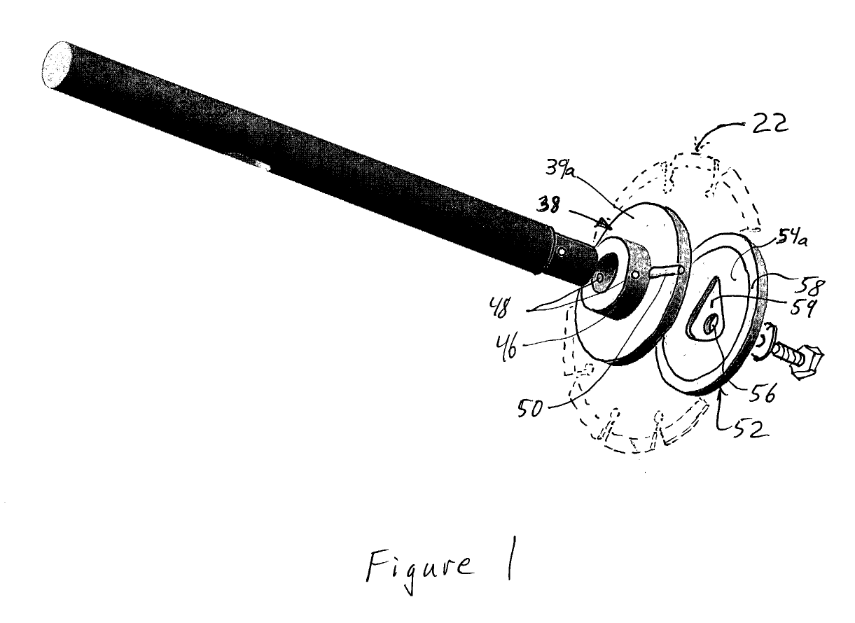

The cutting blade 22 is mounted on an arbor or drive shaft 28 (FIGS. 1 & 2) to rotate with the drive shaft 28 about a longitudinal axis of the drive shaft. The drive shaft 28 is preferably cylindrical but cross-sectional shapes other than circles could be used. A driven end of the drive shaft is in driving communication with the motor 26 by means known in the art and not described in detail here. Such means typically include a belt drive, chain drive, or gear drive.

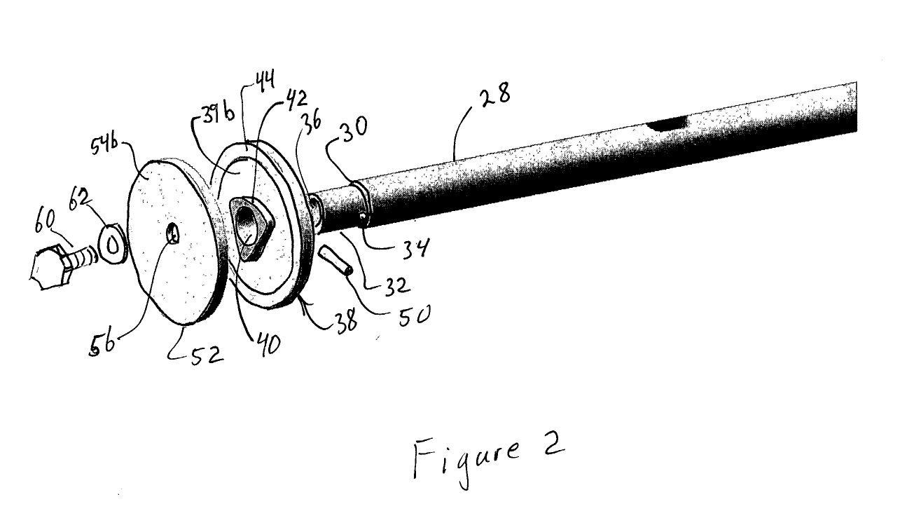

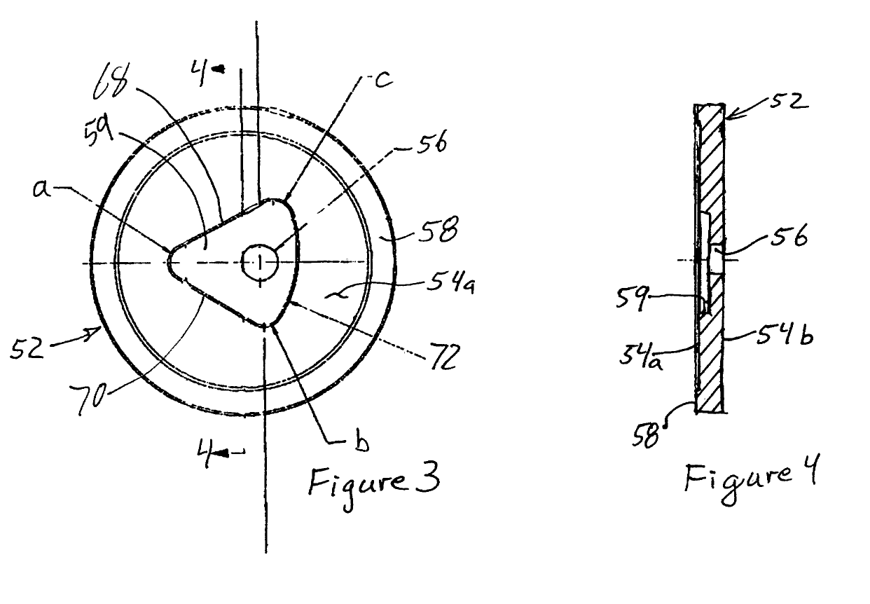

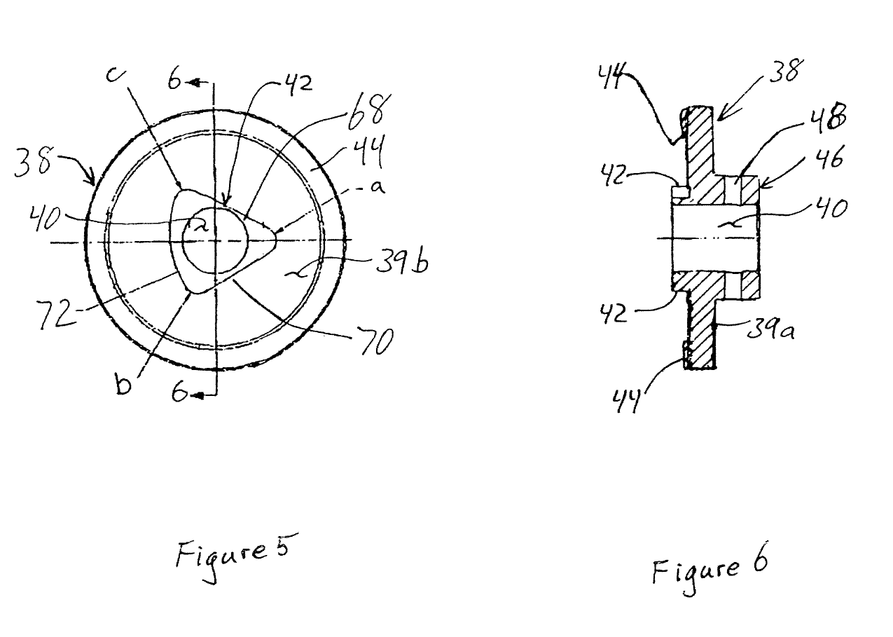

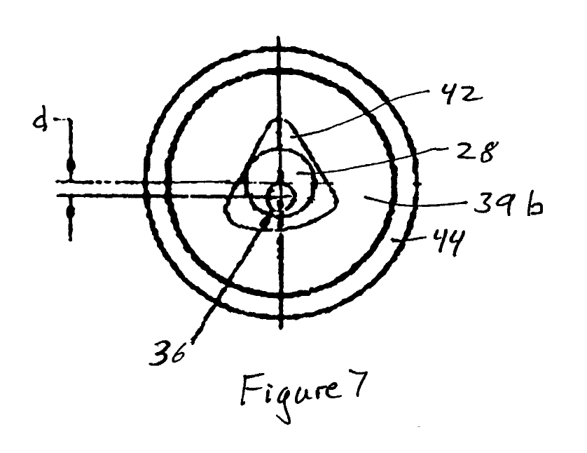

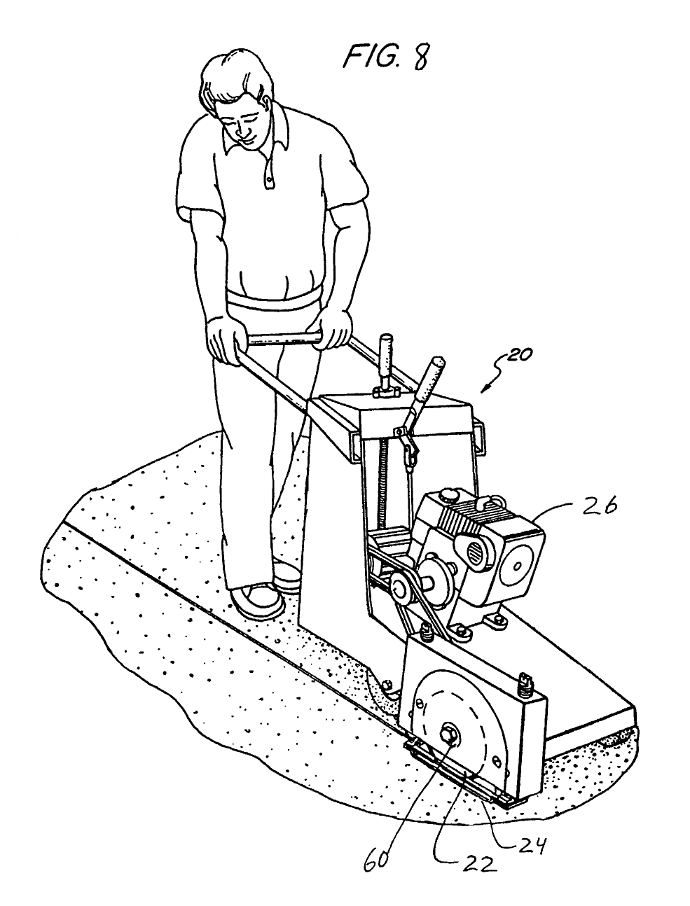

Referring to FIGS. 1-6, the distal end of the drive shaft 28 preferably, but optionally has a shoulder 30 defining the beginning of a reduced diameter end section 32 on the distal end of the drive shaft opposite the driven end of the shaft. A hole 34 extends into and preferably radially through the drive shaft 28. A threaded recess 36 (FIG. 2) is formed in the distal end of the drive shaft 28 generally parallel to a longitudinal axis of the drive shaft.

An arbor sleeve 38 has a mounting hole 40 extending through the sleeve 38 and sized to slidably fit over the mounting end section 32. The hole 40 is generally parallel to the rotational axis of drive shaft 28. The arbor sleeve is preferably a disc with opposing faces 39a, 39b, and a circular periphery, although other shapes can be used. A specially shaped blade mounting portion 42 is provided. The mounting portion 42 preferably, but optionally extends around the hole 40 so as to entirely surround the hole. The mounting portion 42 has a shape that is not-symmetric and so the cutting blade 22 can be mounted in only one orientation so as to correctly orientate the blade 22. The cutting blade 22 has a mating hole at its center so the blade can snugly mount on the blade mounting portion 42 and rotate about the rotational axis with the arbor sleeve.

The mounting portion 42 advantageously has a generally triangular shape. The mounting portion 42 preferably, but optionally, has a geometric center with the hole 40 being offset from that geometric center. The blade mounting portion is described in further detail in U.S. Pat. No. 5,303,688 to Chiuminatta, et. al., titled Mounting Arbor for Saw Cutting Blades, the entire contents of which are incorporated herein by reference. The blade mounting portion will also be discussed later.

The faces 39a, 39b are formed on opposing sides of a disc that extends orthogonal to the rotational axis of the drive shaft 28. A flange 44 is located on face 39b. Flange 44 extends generally parallel to the longitudinal and rotational axis of drive shaft 28. The flange is preferably short, extending a few hundredths of an inch from the face 39b in order to avoid deformation of the disc forming the arbor sleeve during use. A flange 44 extending about 0.04 inches is preferred, longer flanges are suitable for use. In the depicted embodiment, the flange 44 forms a first annular flange extending from the mounting sleeve 38 generally parallel to and encircling the rotational axis.

Referring to FIGS. 1, 2, 6 and 9, the face 39a has a boss 46 extending therefrom. The mounting hole 40 extends through the boss. The boss is preferably cylindrical in shape. The mounting hole 40 is preferably sized to snugly fit over the end section 32. Another hole 48 extends radially through the boss 46 and opens into the mounting hole 40, and preferably extends entirely through the boss. A pin 50 is sized to fit through the hole 48.

During use, the mounting hole 40 of arbor sleeve 38 slides over the end section 32 of drive shaft 28 until the boss 46 abuts the shoulder 30. The shoulder 30 restrains motion of the arbor sleeve 38 toward the driven end of the drive shaft 28. Pins, flanges or other restraining devices could be used instead of the shoulder 30 to restrain the motion of the sleeve 38 along the length of the drive shaft 28. The preferably hole 34 in shaft 28 aligns with the preferably round hole 48 in the boss 46 to allow insertion of pin 50 in order pin the arbor sleeve 38 to the drive shaft 28 so the arbor sleeve 38 rotates with the drive shaft.

During use, a blade is mounted on the blade mounting portion 42, with the end portion 32 of shaft 28 extending through the mounting sleeve 38 and blade 22. Advantageously, a clamping plate 52 urges the blade toward the mounting sleeve 38 to further grip the blade.

The clamping plate 52 preferably comprises a disc having opposing faces 54a, 54b, with a circular periphery, although other shapes could be used. The clamping plate 52 has a hole 56 near the center of the disc and extending through the disc. The face of the clamping plate 52 that is facing toward the drive shaft 28 has a flange 58 around the periphery of the disc. Flange 58 extends generally parallel to the longitudinal and rotational axis of drive shaft 28. The flange 58 is preferably short, extending a few hundredths of an inch from the face 54a in order to avoid deformation of the clamping plate 52 during use. A flange 58 extending about 0.04 inches from the face of the plate 52 is preferred, but longer flanges could be suitable for use. The flange 58 in the depicted embodiment forms a second annular flange extending from the clamping plate generally parallel to and encircling the rotational axis and extending toward the mounting sleeve 38 and flanges 44.

Referring to FIGS. 1, 3 and 9, the face 54a of the clamping plate 52 has a recess 59 sized and shaped to engagingly receive the blade mounting portion 42. Advantageously, the recess 59 is deep enough, or extends into the clamping plate 52 sufficiently to allow a cutting blade 22 to be clamped between flanges 44, 58. The hole 56 in the clamping plate is preferably located within the recess 59. Moreover, the recess 59 is preferably sized and shaped so that the blade mounting portion 42 drivingly engages the mating portions of the recess, at least along the flat portions of the blade mounting portion, as discussed in more detail later.

Preferably, but optionally, the distal end of shaft 28 ends flush or before with the edge of the arbor sleeve facing the clamping plate 52 so that the end of the shaft 28 does not extend beyond the mounting sleeve 38, and in particular does not extend beyond the mounting portion 42 in which the hole 40 is located. That construction prevents the shaft 28 from hitting the clamping plate and preventing the clamping plate from being pushed sufficiently close to the mounting sleeve 38 to grip the blade 22.

A fastener 60 is sized to fit through hole 56 and fasten to shaft 28. Preferably, the fastener 60 comprises a threaded fastener such as a bolt, that theadingly engages the threaded recess 36 on the distal end of the drive shaft 28. A washer 62 is advantageously, but optionally, placed over the threaded shaft of the bolt when the fastener comprises a bolt.

During use, the arbor sleeve 38 is fastened to shaft 28 so the sleeve rotates with drive shaft 28. The circular cutting blade 22 is placed on the blade mounting portion 42 and pushed against the flange 44 on arbor sleeve 38. The clamping plate 52 is placed against the cutting blade 22 and fastener 60 inserted through the hole in the clamping plate and releasably engages the distal end of the shaft 28, as for example, by threadingly engaging recess 36. Washer 62 is interposed between the head of the bolt 60 and the clamping plate 52. The male blade mounting portion 42 extends into the female recess 59 to allow the blade 22 to be clamped between the flanges 44, 58. To help orientate the clamping plate, printed indicia, preferably including the shape of the recess 59 or mounting portion 42, can be placed on the exterior surface of the clamping plate. That allows a user to visually align the clamping plate with the mounting portion and thus mate the mounting portion 42 with the recess 59.

The flanges 44, 58 are preferably located to be the same distance from the rotational axis of the drive shaft 28 so the flanges press against opposing sides of the cutting blade 22 on directly opposing portions of the blade. The flanges 44, 58 are preferably parallel to each other, and orthogonal to the rotational axis of the drive shaft 28. That location and orientation allows frictional clamping of the blade between the flanges 44, 58 without distorting or deforming the blade 22. The fastener 60, such as a bolt, can be tightened to frictionally clamp the blade 22 between the flanges 44, 58.

The flanges 44, 58 need not be at the periphery of their respective mounting sleeve and clamping plate, but are preferably aligned in order to avoid bending the blade 22. The flanges 44, 58 are slightly offset from the radially extending portions of the mounting sleeve 38 and clamping plate 52. If the flanges 44, 58 are long, then over-tightening the fastener 60 could apply sufficient force to the center of the clamping plate 52 or the arbor sleeve 38 to cause the flanges to dish and deform into non-parallel configurations that will apply uneven clamping pressures to the blade 22. By providing a small length of the flanges 44, 58, the amount of deformation is limited because the center of the clamping plate 52 will hit the shaft 28 or blade 22 and stop further deformation.

The flanges are preferably at a larger radius than the blade mounting portion 42 in order to provide support to the cutting blade 22 closer to the cutting segments on the blade and thus provide a more stable and stiffer rotating cutting blade. Advantageously, the flanges 44, 58 are about 0.4 inches wide along a radial direction, with an outer periphery of about 2 inches from the rotational axis of drive shaft 28. But other dimensions can be used.

The use of a removable fastener, such as bolt 60, has several advantages. The bolt 60 can be made of harder or stronger material than the drive shaft 28. Thus, if the blade 22 or blade mounting becomes hot and thermally expands and tightens the bolt making it difficult to remove, a user can apply greater torque to the bolt 60 without breaking the bolt. If the bolt does twist off, the recess 36 can be drilled out and re-tapped for use with a larger bolt without having to remove and replace the entire drive shaft. Previously, the drive shaft had a male projection that was threaded with a nut clamping the blade to the shaft, and that projection was made of the same, softer steel as the shaft. If the threaded projection twisted off, the entire drive shaft had to be replaced. Thus, the use of a fastener 60, especially the use of a male, threaded fastener 60 in conjunction with a mating female recess 36 on the drive shaft, provides advantages.

The pin 50 also acts as a shear pin to allow rotation of the arbor sleeve 38 relative to the shaft 28 if sufficient torque is applied to shear the pin. Sometimes when the cutting blade 22 nears the end of a cut on a slab of concrete the concrete will sag downward and pinch the blade between two slabs of the cut concrete. The concrete can pinch the cutting blade 22 sufficiently that it will stop rotating. The shear pin 50 will shear off in such situations and prevent damage to the engine and other portions of the drive train that transfer rotational power from the engine to the cutting blade. If this torque release is not desired, the arbor sleeve 38 can be permanently fastened to the shaft 28, by for example, welding, casting or other permanent mounting mechanisms. Alternatively, the sleeve 38 could be mounted in a non-rotating manner to the shaft, as for example by using mating splines on the boss 46 and shaft 28, or by using a set screw as shown in FIG. 9.

Referring to FIGS. 2, 5, 7 and 9, the blade mounting portion 42 has a generally triangular shape with two straight or flat sides 68, 70 and one curved side 72 that are preferably, but optionally joined by rounded corners. The curved side 72 has a radius of curvature of about 1.75 inches. But various non-symmetric shapes could be used that allow the blade 22 to be mounted in only one orientation on the axis of rotation. For the depicted shape, the corners a, b and c have radii of about 0.21 inches, 0.23 inches, and 0.26 inches, respectively. In order to prevent the blade 22 from moving on the mounting portion 42, the actual tolerances preferably match more closely than the specified dimensions, but the actual dimension will vary with the shapes, materials and manufacturing methods selected. The mounting portion 42 advantageously has at least one straight side, and preferably has two or more straight sides 68, 70 in order to drivingly engage mating surfaces on the cutting blade 22 and provide a direct contact with the blade to rotate the blade.

Referring to FIGS. 1-3, 7 and 9, the center of hole 56 in clamping plate 52 is preferably, but optionally, offset from a geometric center of the plate, and is further preferably but optionally also offset from the rotational axis of the drive shaft 28. The amount of the offset will vary with the particular design that is selected. The offset arises from attempts to more accurately dynamically balance the rotating blade and its mounting portions. The cutting blade 22 can rotate at over 4,000 RPM, although the rotational speed will vary with the particular blade diameter and saw being used. Small imbalances can exert destructive forces on the saw 20, on the drive train used to rotate blade 22, and can cause the cut formed by blade 22 to vary in quality and width.

The center of mass of the triangular mounting portion is also not located on the rotational axis of drive shaft 28. The center of mass of the mounting sleeve 38, clamping plate 52, pin 50, washer 62, fastener 60, end section 32 with recess 36, and blade 22, can be determined and the parts located so that when assembled, the center of mass of the assembly is on or within a predetermined and acceptable distance of the rotational axis of drive shaft 28. This results in a smoother running saw 20, with less wear and tear on the drive train and saw, and with better cuts from the cutting blade 22. Advantageously, for concrete saws the center of mass of the blade 22, arbor sleeve 38, clamping plate 52, washer 62, bolt 60 and the recessed end 32 is offset by 0.005 inches or less, advantageously 0.001 inches or less, and preferably offset by about 0.0005 inches or less.

Thus, as best seen in FIGS. 7 and 9, the hole 36 in shaft 28 that threadingly receives bolt 60 is not on the center axis or rotational axis of the drive shaft 28. Rather, it is offset from the center of the drive shaft a distance d of about 0.23 inches toward what corresponds to the curved side 72 of the generally triangular mounting portion 42. In the depicted embodiment, the recess 36 preferably has over 75% of the diameter of the recess offset from the rotational axis of the shaft 28, and preferably has the periphery of the recess 36 on or within 0.125 inches of the rotational axis while still being within the diameter of the drive shaft 28. The pin 50 can be used to locate the mounting portion 42 and mounting sleeve 38 at the correct orientation relative to the recess 36.

The hole 56 in clamping plate is preferably circular, but the center of hole 56 in the generally triangular shaped recess 59 is not located at the center of circular clamping plate 52. Instead, it is offset a distance of about 0.23 inches from the geometric center of the circular plate 52. The offset is toward what corresponds to the curved side 72 of the generally triangular shape. The precise distance and orientation will vary with the dimensions, shapes and location of the mounting portion 42, and the density of the materials selected for the various components.

The recess 59 helps align or center the clamping plate 52 and avoid tight (and expensive) manufacturing tolerances on the location of hole 56. Previously, a clamping plate with a non-contacting center portion was used, but that required the hole 56 be used to center the clamping plate relative to the rotational axis of the drive shaft During use of the concrete saws concrete dust abrades the hole 56 and degrades the centering accuracy. The wear associated with the repeated removal of the clamping plate 52 in order to replace cutting blades 22 also reduces the ability of the hole 56 to accurately center the clamping plate 52. As a result, the prior art clamping plates required tight and expensive manufacturing tolerances on the holes 56 and the mounting accuracy degraded with use. The recess 59 avoids these centering inaccuracies and allows lower manufacturing tolerances on the hole 56, resulting in a more accurate dynamically balanced mount that retains that balance and at a potentially lower cost. Further, the increased length of the engaging surfaces around the periphery of the mounting arbor 42 and recess 59 provide not only an increased alignment accuracy, but an increased surface for wear so that repeated use does not appreciably degrade the mounting accuracy. The vibration during normal operating speeds of the blade 22 is not believed to change more than 10% because of the wear or other inaccuracies associated with the nested mounting arbor 42 and recess 59 during the lifetime of the bearings supporting the drive shaft 28.

Preferably, the recess 59 is sized and shaped to engage and align with at least one location, advantageously two locations, preferably three locations, and more preferably the entire periphery of the mounting portion 42. When three locations are used, the locations are preferably each on a different one of the sides 68, 70 and 72. Alternatively, the corners a, b or c could be used instead of locations on the sides 68, 70, 72. It is less preferred, but still advantageous, to use even a single location for alignment, but more advantageously two or more locations on the mounting arbor sleeve 38 are used. Thus, a single flat side 68 or 70 (or corners a, b, c) could be used to orientate and position the clamping plate 52. This could be done by locating an engaging surface on a reconfigured clamping plate where that engaging surface is located and oriented to engage the selected portion or portions of the blade mounting portion 42 on the sleeve 38 that extends through the blade 22 in order to place the revised clamping plate 52 in the correct orientation and location for dynamic balancing while still clamping the blade 22 between the flanges 44, 58.

Thus, for example, one or more pins or ledges could extend from face 54a toward the mounting sleeve 38, with the pins or ledges located to engage with a periphery of the blade mounting portion 42 or the hole 40 in order to orientate and center the reconfigured clamping plate 52 relative to the rotational axis of the shaft 28 and preferably, but optionally also relative to the arbor sleeve 38. Likewise, a recess with one or more edges could receive and/or abut one or more portions of the mounting portion 42 or hole 40. The recess 59 is defined by a plurality of walls, and those walls can correspond to a plurality of pins or ledges extending from plate 52 to form the recess. In the preferred embodiment, a recess 59 is formed having three sides and three curves located to mate with the entire periphery of the blade mounting portion 42. The mounting portion 42 and recess 59, along with the above described variations on those parts provide means for aligning the arbor sleeve 38 with the clamping plate 52.

There is thus provided a mounting assembly for a rotating cutting blade that uses a non-symmetric mounting portion in order to orientate the blade in a desired rotational direction, while providing for a more secure mounting portion by engaging one or more flats on the cutting blade and mounting sleeve, and centering a clamping plate by nesting the non-symmetric mounting portion in a mating recess in the clamp plate.

The blade mounting portion 42, or parts thereof, and recess 59, or parts thereof and modifications thereof, advantageously provided a means for aligning a clamping plate 52 with an arbor sleeve 38 so that flanges 44, 58 on the sleeve and clamping plate, respectively, are aligned on directly opposing sides of a blade 22 in order to frictionally engage the blade, preferably, but optionally, without distorting the blade. The blade mounting portion 42, or parts thereof, and recess 59, or parts thereof and modifications thereof, also advantageously provided a means for aligning a clamping plate 52 with the arbor sleeve 38 to improve the dynamic balancing of the mounted blade 22.

As described above, the rotational axis of the blade 22 coincides with the rotational axis of the drive shaft 28. That need not be so for the entire drive shaft as gearing, pulleys or other drive components can be interposed between the shaft 28 and the distal end 32. In such a configuration, the distal end 32 containing the recess 36 is still considered part of the drive shaft 28.

The above description is given by way of example, and not limitation. Given the above disclosure, one skilled in the art could devise variations that are within the scope and spirit of the invention, including various ways of configuring the mounting portion and arranging the rotating parts to reduce rotationally induced vibration. Moreover, the threaded fastener 60 could be fastened to the clamping plate 52 in a non-removable manner rather than being removable, as for example by placing a snap-ring in a groove located inside the clamp plate 52 so as to allow the fastener 60 to rotate, but be connected to and not removable from the plate 52. The various features of this invention can be used alone, or in varying combinations with each other and are not intended to be limited to the specific combination described herein. Thus, the invention is not to be limited by the illustrated embodiments but is to be defined by the following claims when read in the broadest reasonable manner to preserve the validity of the claims.

What is claimed is:

1. A portable concrete saw for use with a rotating concrete cutting blade that is rotated about a rotational axis by rotating drive shaft mounted to the saw and driven by a motor on the saw, comprising:
a threaded recess in a distal end of the drive shaft, the recess aligned parallel to the rotational axis but offset from that axis;
an arbor sleeve mounted to and rotating with the distal end of the drive shaft, the sleeve having a non-symmetric blade mounting portion thereon, the sleeve having a hole therethrough parallel to the rotational axis;
a clamping plate having at least one part thereon that is aligned with and configured to abut at least one portion of the blade mounting portion in order to align the plate to rotate about the rotational axis, the plate having a geometric center with a hole through the plate parallel to the rotational axis but offset from the geometric center; and
a threaded fastener extending through the hole in the plate and threadingly engaging the recess in the distal end of the drive shaft.

2. The saw of claim 1, wherein the blade is mounted on and rotates with the mounting portion.

3. The saw of claim 1, wherein the mounting portion has two straight sides and one curved side forming a generally triangular shape.

4. The saw of claim 1, wherein the mounting portion includes a first structure extending orthogonal to the rotational axis with a first annular flange extending from the first structure generally parallel to and encircling the rotational axis and extending toward the clamping plate, and wherein the clamping plate includes a second structure extending orthogonal to the rotational axis with a second annular flange extending from the second structure generally parallel to and encircling the rotational axis and extending toward the first flange.

5. The saw of claim 4, wherein the first and second flanges frictionally engage opposing sides of the blade at the same distance from the rotational axis.

6. The saw of claim 1, wherein the mounting sleeve is fastened to the drive shaft by a shear pin.

7. A concrete saw having a drive shaft, comprising:
an arbor sleeve connected to and rotating with the drive shaft, the sleeve having a non-symmetric blade mounting portion thereon, the sleeve having a hole therethrough parallel to the rotational axis; and
a clamping plate having at least one part thereon that is aligned with and configured to abut at least one portion of the blade mounting portion in order to align the plate to rotate about the rotational axis, the plate having a geometric center with a hole through the plate parallel to the rotational axis but offset from the geometric center.

8. The saw of claim 7, further comprising a threaded recess in a distal end of the drive shaft, the recess aligned generally parallel to the rotational axis but offset from that axis.

9. The saw of claim 8, further comprising a threaded fastener extending through the hole in the plate and threadingly engaging the recess in the distal end of the drive shaft.

10. The saw of claim 7, wherein the blade is mounted on and rotates with the mounting portion.

11. The saw of claim 7, wherein the mounting portion has two straight sides and one curved side forming a generally triangular shape.

12. The saw of claim 7, wherein the mounting portion includes a first annular flange extending generally parallel to and encircling the rotational axis and extending toward the clamping plate, and wherein the clamping plate includes a second annular flange extending from the second structure generally parallel to and encircling the rotational axis and extending toward the first flange.

13. The saw of claim 12, wherein the first and second flanges frictionally engage opposing sides of a concrete saw blade at the same distance from the rotational axis.

14. The saw of claim 7, wherein the mounting sleeve is fastened to the drive shaft by a shear pin.

15. A concrete saw having a drive shaft, comprising:
an arbor sleeve connected to and rotating with the drive shaft, the sleeve having a non-symmetric blade mounting portion thereon, the sleeve having a hole therethrough parallel to the rotational axis; and
a clamping plate having at least one part thereon that is aligned with and configured to abut at least one portion of the blade mounting portion in order to align the plate to rotate about the rotational axis, the plate having a geometric center with a threaded fastener connected to the plate and extending parallel to the rotational axis and toward the arbor sleeve and offset from the geometric center.

16. The concrete saw of claim 15, further comprising a threaded recess in the drive shaft extending along the rotational axis of the shaft, and wherein the threaded fastener engages the threaded recess.

17. The concrete saw of claim 16, further comprising a first annular flange on the arbor sleeve encircling the rotational axis and extending toward the clamping plate, and a second annular flange on the clamping plate encircling the rotational axis and extending toward the first flange, the flanges located to clamp the blade between the flanges at a common radial distance from the rotational axis.

18. A method for mounting a rotating cutting blade on a portable concrete saw that rotates the blade about a rotational axis by a rotating drive shaft mounted to the saw and driven by a motor on the saw, comprising:
placing a threaded recess in a distal end of the drive shaft and aligning the recess parallel to the rotational axis but offset from that axis;
connecting an arbor to and rotating the arbor with the distal end of the drive shaft, the sleeve having a non-symmetric blade mounting portion thereon; and
aligning a clamping plate having at least one projection thereon so the projection is aligned with and configured to overlap at least one portion of the blade mounting portion and align the plate to rotate about the rotational axis, the plate having a geometric center with a hole through the plate parallel to the rotational axis but offset from the geometric center.

19. The method of claim 18, further comprising:
extending a threaded fastener through the hole in the plate and threadingly engaging the recess in the distal end of the drive shaft to clamp the blade between the arbor sleeve and the clamping plate.

20. The method of claim 18, further comprising forming the mounting portion to have two straight sides and one curved side to form a generally triangular shape.

21. The method of claim 18, further comprising providing a first annular flange extending from the arbor sleeve generally parallel to and encircling the rotational axis and extending toward the clamping plate, and providing the clamping plate with a second annular flange generally parallel to and encircling the rotational axis and extending toward the first flange, so the first and second flanges frictionally engage opposing sides of the cutting blade at a common radial distance from the rotational axis.

22. The method of claim 18, further comprising fastening the mounting sleeve to the drive shaft by a shear pin.
